(19) United States
(12) Patent Application Publication
(10) Pub. No.: US 2010/0205341 A1
(43) Pub. Date: Aug. 12, 2010

(54) CARD RECOGNITION METHOD FOR MICRO SD ADAPTER

(75) Inventor: I-Ming Chen, Taipei City (TW)

Correspondence Address: SINGIM INTERNATIONAL CORP, P.O. BOX 108-00403, TAIPEL 106, TW

(73) Assignee: SINGIM INTERNATIONAL CORP., Hsin Tien (TW)

(21) Appl. No.: 12/369,002

(22) Filed: Feb. 11, 2009

(51) Int. Cl. G06F 13/00

(52) U.S. Cl. 710/301

(57) ABSTRACT

A card recognition method is disclosed to provide a Micro SD adapter, which has a common insertion slot for the insertion of a M2 memory card or a Micro SD memory card, and a microprocessor with a built-in software program for detecting the potential signal of the inserted memory card and switching on or off the Micro SD memory card signal transmission path or the M2 memory card signal transmission path subject to the detection result, so that an external electronic device to which the Micro SD adapter is electrically connected can communicate with the memory card in the common insertion slot for signal transmission.

### BACKGROUND OF THE INVENTION

1. Field of the Invention

The present invention relates to Micro SD adapter technology and more particularly, to a card recognition method adapted to recognize the type of the memory card that is inserted into a common insertion slot of a Micro SD adapter that is compatible to Micro SD memory card as well as M2 memory card, for enabling the matching signal transmission path to be switched on for communication between the inserted memory card and the external electronic device to which the Micro SD adapter is electrically connected.

2. Description of the Related Art

Following fast development of modern technology, many versatile electric and electronic products have been created and have appeared on the market. For example, digital mobile telephone uses an electronic card (memory card) to record text data, or static or dynamic video data. Nowadays, Micro SD memory card and M2 memory card are intensively used in mobile electronic devices having light, thin, short and small characteristics for the advantage of their small-sized feature.

However, because a Micro SD memory card has a small size, it cannot be directly inserted into the card insertion slot of a regular card reader. When using a card reader to read data from a Micro SD memory card, the Micro SD memory card must be inserted into a Micro SD adapter (MS Pro Duo) so that the Micro SD memory card can be inserted with the Micro SD adapter into the card reader for data transmission. Further, a regular Micro SD adapter simply allows insertion of a Micro SD memory card. When using a card reader to read data from a M2 memory card or any other type of micro or mini memory card, a respective different memory card adapter must be used. Therefore, conventional memory card adapters are not satisfactory in function and have drawbacks as follows:
(1) Because a memory card adapter cannot be used with different micro or mini memory cards, different types of mini and micro memory card adapters shall be provided for use with different types of mini or micro memory cards, increasing the cost.
(2) Because a regular Micro SD adapter allows insertion of a Micro SD memory card only, the original adapter configuration must be changed when adding an additional card passage to a Micro SD adapter for another type of memory card. However, when changed the original adapter configuration of a Micro SD adapter, the original Micro SD adapter configuration becomes not available.

Therefore, it is desirable to provide a way for enabling a Micro SD adapter to be selectively used with a Micro SD memory card or M2 memory card without changing the original adapter configuration.

### SUMMARY OF THE INVENTION

The present invention has been accomplished under the circumstances in view. It is therefore one object of the present invention to provide a card recognition method for Micro SD adapter, which enables a Micro SD adapter to be selectively used with a Micro SD memory card or a M2 memory card.

To achieve this and other objects of the present invention, a card recognition method is to provide a Micro SD adapter (MS Pro Duo), which has a common insertion slot for the insertion of a M2 memory card or a Micro SD memory card, and a microprocessor with a built-in software program for detecting a potential signal of an inserted memory card in the common insertion slot and switching on or off the Micro SD memory card signal transmission path or the M2 memory card signal transmission path subject to the detection result, so that an external electronic device to which the Micro SD adapter is electrically connected can communicate with the memory card that is inserted into the common insertion slot for signal transmission.

Further, the Micro SD adapter (MS Pro Duo) has a first terminal set and a second terminal accommodated in an inside accommodation chamber thereof. When a M2 memory card is inserted into the common insertion slot, it is electrically connected to the first terminal set, and the fifth pin (INS PIN) of the inserted M2 memory card is induced to provide a low-potential signal. When a Mini SD memory card is inserted into the common insertion slot, it is electrically connected to the second terminal set, and a sensor probe in the accommodation chamber of the Micro SD adapter (MS Pro Duo) is induced to provide a high-potential signal.

### BRIEF DESCRIPTION OF THE DRAWINGS

FIG. 1 is a flow chart of the present invention.

FIG. 2 is a system block diagram of the present invention.

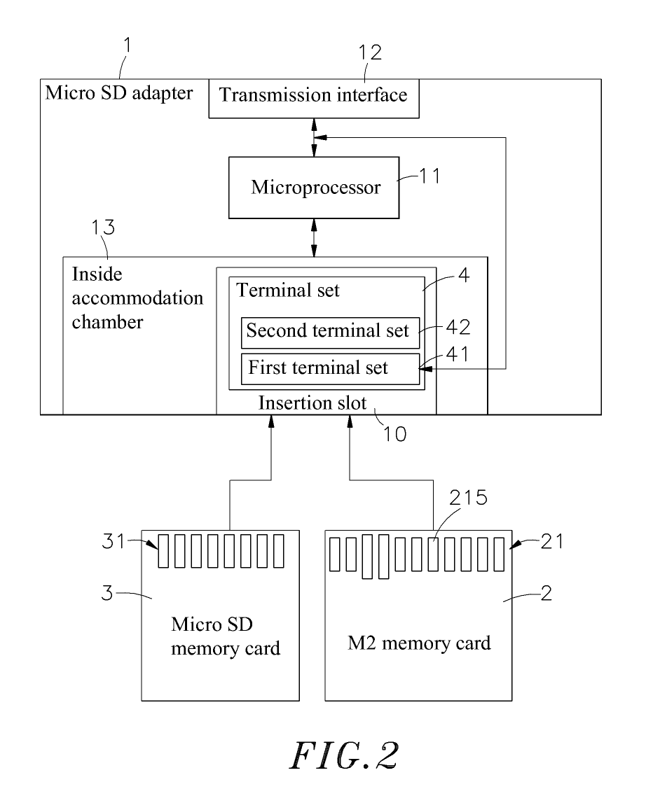

FIG. 3 is an exploded view of a Micro SD adapter constructed according to the present invention.

FIG. 4 is similar to FIG. 2 but showing a Micro SD-to-MS Pro Duo converting IC chip installed in the Micro SD adapter.

FIG. 5 is a chart of an 11-pin interface of a M2 memory card according to the present invention (I).

FIG. 6 is a chart of an 11-pin interface of a M2 memory card according to the present invention (II).

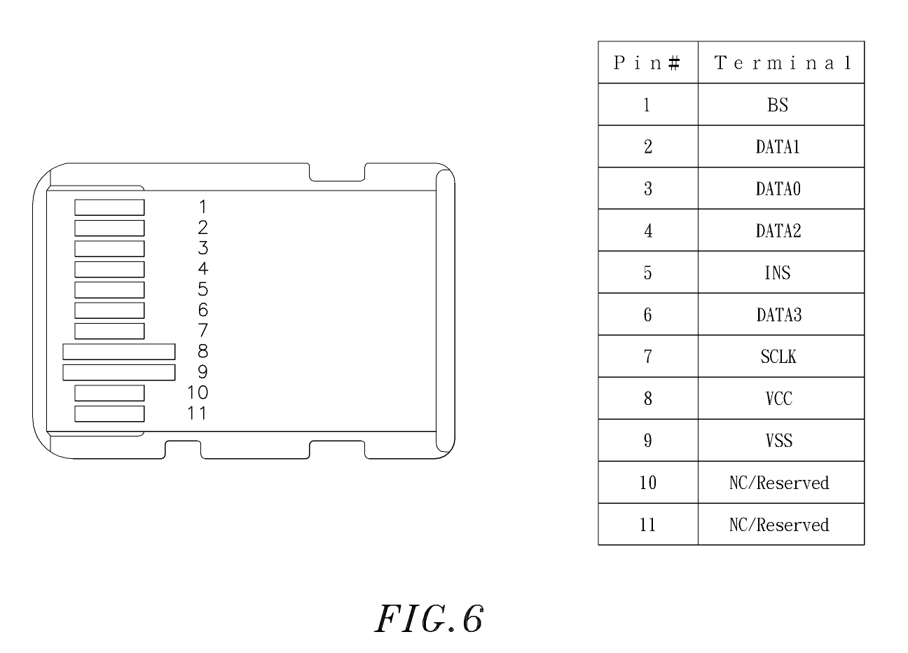

FIG. 7 is a chart of an 8-pin interface of a Micro SD memory card according to the present invention.

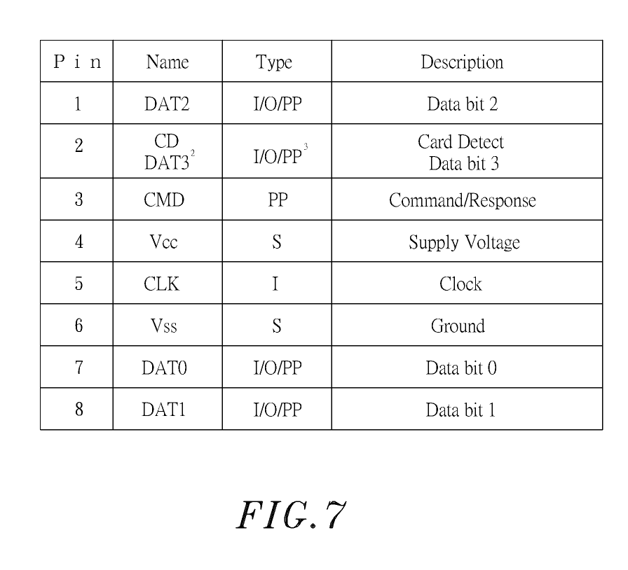

### DETAILED DESCRIPTION OF THE PREFERRED EMBODIMENT

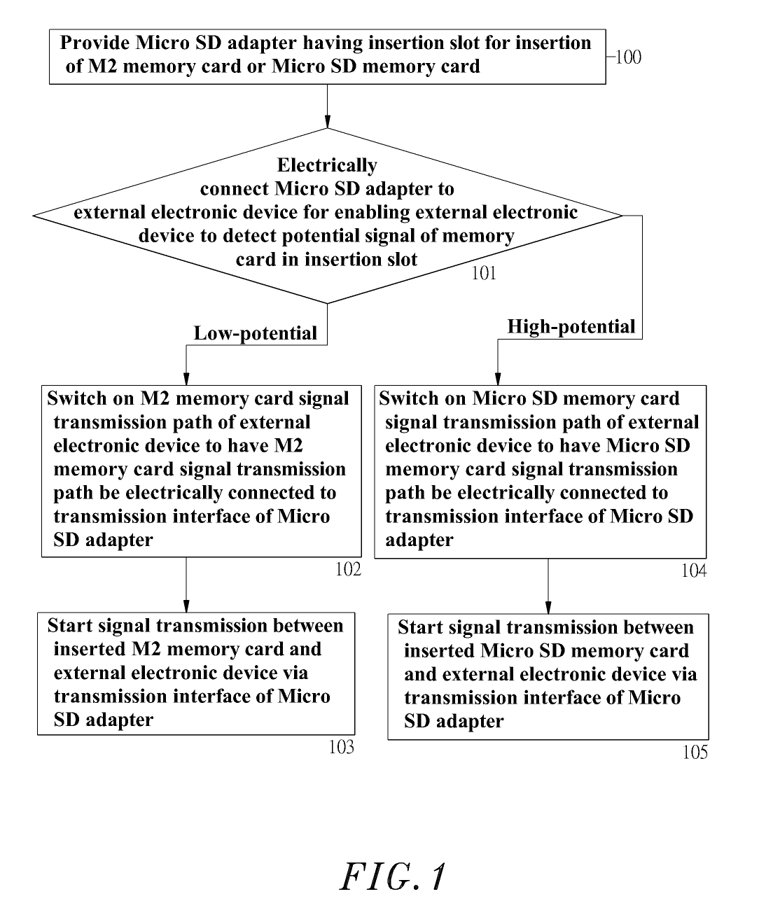

Referring to FIGS. 1˜3, a card recognition method for Micro SD adapter in accordance with the present invention includes the steps of:
(100) Provide a Micro SD adapter 1 that has a built-in microprocessor 11 and an insertion slot 10 for the insertion of a M2 memory card 2 or Micro SD memory card 3.
(101) Electrically connect the Micro SD adapter 1 to an external electronic device for enabling the external electronic device to detect a potential signal of a memory card in the insertion slot 10 by means of the microprocessor 11, and then proceed to step (102) when a low-potential signal is detected where a M2 memory card is inserted into the insertion slot 10, or to step (104) when a high-potential signal is detected where a Micro SD memory card 3 is inserted into the insertion slot 10.
(102) Switch on a M2 memory card signal transmission path of the external electronic device to electrically connect the M2 memory card signal transmission path to a transmission interface 12 of the Micro SD adapter 1.
(103) Start signal transmission from the inserted M2 memory card 2 through the transmission interface 12 of the Micro SD adapter 1 to the external electronic device.
(104) Switch on a Micro SD memory card signal transmission path of the external electronic device to electrically connect the Micro SD memory card signal transmission path to the transmission interface 12 of the Micro SD adapter 1.
(105) Start signal transmission from the inserted Micro SD memory card 3 through the transmission interface 12 of the Micro SD adapter 1 to the external electronic device.

The aforesaid Micro SD adapter 1 can be a MS Pro Duo type adapter having only one insertion slot 10. Further, the microprocessor 11 of the Micro SD adapter 1 has stored therein a software program capable of detecting high-potential and low-potential signals. Further, the Micro SD adapter 1 comprises an inside accommodation chamber 13 in communication with the insertion slot 10, the terminal sets 4 mounted in the inside accommodation chamber 13. The terminal sets 4 include a first terminal set 41 configured to fit a M2 memory card 2, and a second terminal set 42 configured to fit a Micro SD memory card 3. When a M2 memory card 2 is inserted into the insertion slot 10, it is electrically connected to the first terminal set 41. When a Micro SD memory card 3 is inserted into the insertion slot 10, it is electrically connected to the second terminal set 42.

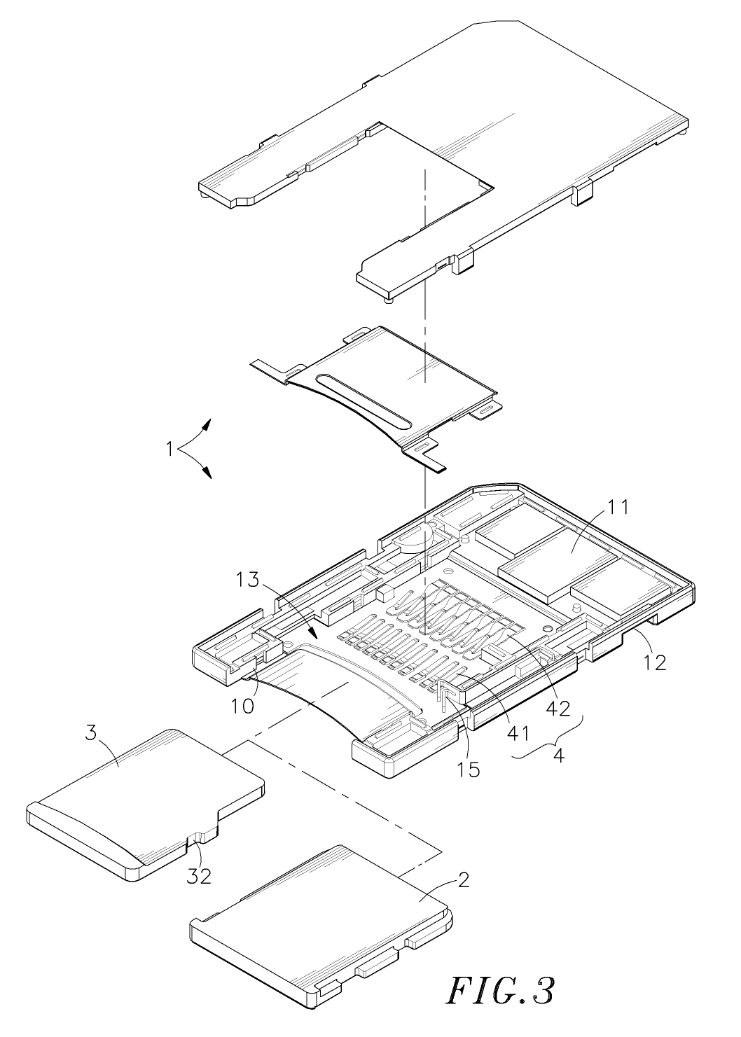

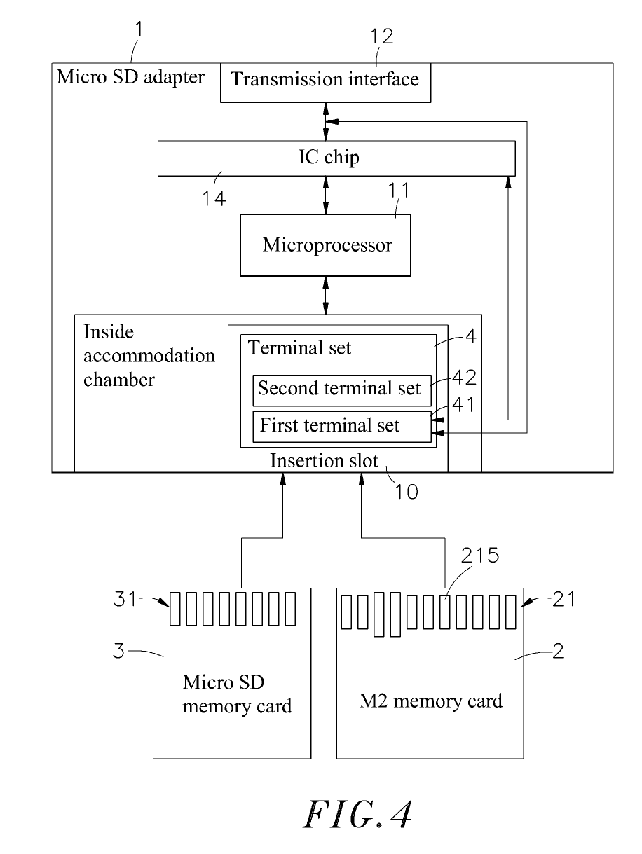

Referring to FIG. 4 and FIG. 3 again, the Micro SD adapter 1 further has an IC chip 14 installed therein and adapted to convert Micro SD format into MS Pro Duo format. The IC chip 14 has built therein a software program capable of scanning INS PIN of fifth metal contacts 215 of a M2 memory card 2. When a Micro SD memory card 3 is inserted into the insertion slot 10, the Micro SD memory card 3 is electrically connected to the second terminal set 42, and at this time, enabling the microprocessor 11 to get the signal of the Micro SD memory card 3.

When the Micro SD adapter 1 is electrically connected to an external electronic device (such as a card reader, a desktop computer, notebook computer or PDA that is equipped with a card reader), the external electronic device detects, through the IC chip 14, the potential signal of the memory card that is inserted into the Micro SD adapter 1. When a high-potential signal is detected, it means a Micro SD memory card 3 is inserted into the insertion slot 10 of the Micro SD adapter 1, and at this time the microprocessor 11 opens the signal path within the Micro SD memory card 3, the IC chip 14 and the transmission interface 12 of the Micro SD adapter 1 and the IC chip 14 cuts off the signal path between the first terminal set 41 and the insertion slot 10, allowing the signal of the inserted Micro SD memory card 3 to be transmitted through the microprocessor 11, the IC chip 14 and the transmission interface 12 of the Micro SD adapter 1 to the external electronic device. On the contrary, when a low-potential signal is detected, it means a M2 memory card 2 is inserted into the insertion slot 10 of the Micro SD adapter 1, and at this time the microprocessor 11 opens the signal path within the M2 memory card 2, the IC chip 14 and the transmission interface 12 of the Micro SD adapter 1 and the IC chip 14 cuts off the signal path between the second terminal set 42 and the insertion slot 10, allowing the signal of the inserted M2 memory card 2 to be transmitted through the microprocessor 11, the IC chip 14 and the transmission interface 12 of the Micro SD adapter 1 to the external electronic device.

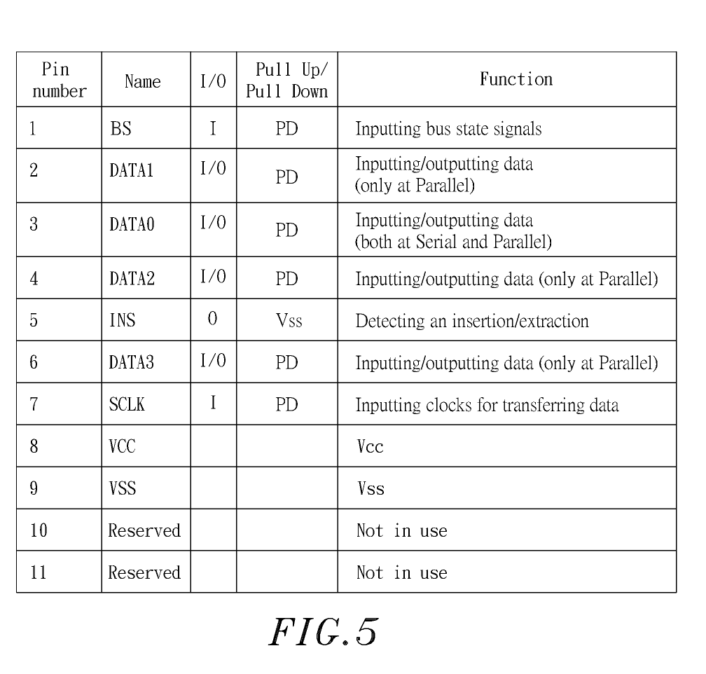

Referring to FIGS. 5˜7 and 2˜4 again, a M2 memory card 2 has an 11-pin interface 21 in which the fifth pin (metal contact) 215 is the INS PIN for detecting an insertion/extraction. When a M2 memory card 2 is inserted into the insertion slot 10 of the Micro SD adapter 1, the 11-pin interface 21 is electrically connected to the first terminal set 41, enabling the microprocessor 11 or the IC chip 14 to detect the low-potential signal of the fifth pin 215, and therefore the insertion of the M2 memory card 2 in the insertion slot 10 of the Micro SD adapter 1 is detected.

Further, a Micro SD memory card 3 has 8-pin interface 31. When a Micro SD memory card 3 is inserted into the insertion slot 10 of the Micro SD adapter 1, a side notch 32 of the Micro SD memory card 3 is forced into contact with a sensor probe 15 in the inside accommodation chamber 13 of the Micro SD adapter 1, causing the sensor probe 15 to provide a high-potential signal indicative of the insertion of the Micro SD memory card 3 in the insertion slot 10 to the microprocessor 11.

As stated above, the Micro SD adapter 1 provides a common insertion slot 10 for the insertion of a M2 memory card 2 or a Micro SD memory card 3. By means of built-in memory card detecting software program, the microprocessor 11 of the Micro SD adapter 1 is capable of detecting different types of memory cards. When the Micro SD adapter 1 is electrically connected to an external electronic device, the electronic device detects the high-potential or low-potential signal of the inserted memory card by means of the microprocessor 11 of the Micro SD adapter 1, and then switches on the transmission path subject to the type of the inserted memory card and simultaneously switches off the transmission path that is not in conformity with the inserted memory card, allowing transmission of signal between the inserted memory card and the external electronic device.

In conclusion, the card recognition method for Micro SD adapter in accordance with the present invention has the following features and advantages:
1. When the Micro SD adapter 1 is electrically connected to an external electronic device, the external electronic device detects the insertion of a memory card in the insertion slot 10 of the Micro SD adapter 1 by means of the microprocessor 11. When a M2 memory card 2 is inserted into the insertion slot 10 of the Micro SD adapter 1, the low-potential signal of the fifth pin 215 of the M2 memory card 2 is detected, and the transmission path of the first terminal set 41 and the transmission interface 12 of the Micro SD adapter 1 is switched on for signal transmission. When a Micro SD memory card 3 is inserted into the insertion slot 10 of the Micro SD adapter 1, the sensor probe 15 of the Micro SD adapter 1 provides a high-potential signal to switch on the transmission path of the second terminal set 42 and the transmission interface 12 of the Micro SD adapter 1 for signal transmission.
2. The insertion slot 10 of the Micro SD adapter 1 extends to the inside accommodation chamber 13 that accommodates two terminal sets 4, i.e., the first terminal set 41 to fit a M2 memory card 2 and the second terminal set 42 to fit a Micro SD memory card 3. Therefore, the insertion slot 10 is a common slot for the insertion of a M2 memory card 2 and a Micro SD memory card 3 alternatively.
3. The Micro SD adapter 1 has its inside accommodation chamber 13 accommodate two terminal sets 4 to fit a M2 memory card 2 and a Micro SD memory card 3. Therefore, the Micro SD adapter 1 can selectively receive a M2 memory card 2 and a Micro SD memory card 3 without changing its original configuration.

Therefore, the main feature of the present invention is to provide a Micro SD adapter 1 that allows insertion of a M2 memory card 2 and a Micro SD memory card 3 alternatively. When the Micro SD adapter 1 is electrically connected to an external electronic device, the external electronic device detects the high-potential or low-potential signal of the memory card that is inserted into the Micro SD adapter 1, and switches on the transmission path that is compatible to the type of the memory card that is inserted into the Micro SD adapter 1 and simultaneously switches off the transmission path that is not compatible to the memory card that is inserted into the Micro SD adapter 1.

Although a particularly embodiment of the present invention has been described in detail for enabling any person skilled in the art to know the invention, various modifications and enhancements may be made without departing from the spirit and scope of the invention. Any modifications and enhancements shall not depart from the spirit and scope of the invention. Accordingly, the invention is not to be limited except as by the appended claims.

What the invention claimed is:

1. A card recognition method, comprising the steps of:
(a) providing a Micro SD adapter having insertion slot means for the insertion of a M2 memory card or a Micro SD memory card;
(b) electrically connecting said Micro SD adapter to an external electronic device for enabling said external electronic device to detect a potential signal of a memory card in said insertion slot means through a microprocessor of said Micro SD adapter, and then proceeding to step (c) when a low-potential signal is detected where a M2 memory card is inserted into said insertion slot means, or to step (e) when a high-potential signal is detected where a Micro SD memory card is inserted into said insertion slot means;
(c) switching on a M2 memory card signal transmission path of said external electronic device to electrically connect said M2 memory card signal transmission path of said external electronic device to a transmission interface of said Micro SD adapter;
(d) starting signal transmission from the inserted M2 memory card through said transmission interface of said Micro SD adapter to said external electronic device;
(e) switching on a Micro SD memory card signal transmission path of said external electronic device to electrically connect said Micro SD memory card signal transmission path of said external electronic device to a transmission interface of said Micro SD adapter; and
(f) starting signal transmission from the inserted Micro SD memory card through said transmission interface of said Micro SD adapter to said external electronic device.

2. The card recognition method as claimed in claim 1, wherein said Micro SD adapter is a MS Pro Duo type adapter.

3. The card recognition method as claimed in claim 1, wherein said Micro SD adapter comprises an inside accommodation chamber disposed in communication with said insertion slot means, and terminal means accommodated in said inside accommodation chamber for the contact of a memory card that is inserted into said insertion slot means.

4. The card recognition method as claimed in claim 3, wherein said terminal means comprises a first terminal set configured to fit a M2 memory card.

5. The card recognition method as claimed in claim 3, wherein said terminal means further comprises a second terminal set configured to fit a Micro SD memory card.

6. The card recognition method as claimed in claim 1, wherein said insertion slot means of said Micro SD adapter is a common insertion slot for the insertion of a M2 memory card and a Micro SD card selectively.

7. The card recognition method as claimed in claim 1, wherein said microprocessor of said Micro SD adapter has built therein a software program adapted to switch on/off said Micro SD memory card signal transmission path and said M2 memory card signal transmission path.
